(19) United States
(12) Patent Application Publication
(10) Pub. No.: US 2018/0239516 A1
(43) Pub. Date: Aug. 23, 2018

(54) METHODS FOR GENERATING AND PUBLISHING MICROSITES AND DEVICES THEREOF

(71) Applicant: Usablenet Inc., New York, NY (US)

(72) Inventor: Enrico Scoda, Martignacco (IT)

(21) Appl. No.: 15/440,610

(22) Filed: Feb. 23, 2017

(51) Int. Cl. G06F 3/0481; H04L 29/08; G06F 3/0482; G06F 17/24; G06F 17/22

(52) U.S. Cl. CPC G06F 3/04817; H04L 67/02; G06F 17/2247; G06F 17/248; G06F 3/0482

(57) ABSTRACT

Methods, non-transitory computer readable media, content management apparatuses that provide a widget comprising one or more template fields, an input field, and an indication of an associated web service. The widget when executed is configured to send a web service request including a network address as a parameter to the web service, the network address received via the input field. A web service response is received from the web service. The web service response includes content extracted from a web page corresponding to the network address. One or more portions of the content are mapped to the template fields. The template fields are populated with the one or more portions of the content based on the mapping. A microsite is published based on the populated template fields. With this technology, microsites can be published relatively efficiently without requiring knowledge of the platform used to host the web site content sources.

### FIELD

This technology generally relates to methods and devices for facilitating the generation and publication of microsites.

### BACKGROUND

Increasingly, content providers have a need to quickly publish new web pages that partially replicate the content of main or source web pages. Such new web pages are referred to as microsites, and can include relatively small web pages for mobile phones, temporary web pages related to a particular event occurring for a limited amount of time, or web pages that support marketing campaigns, for example. A microsite can include a product description web page for a “deal of the day” that may need to be published quickly, may only have a limited lifespan, and may only include a product description, a single image of a product, and an edited product price, although many other types of microsites can be published.

Currently, generating and publishing microsites requires a significant amount of effort and time, as well as technical knowledge, by information technology (IT) or software development professionals, of the platforms associated with the main or content source web pages. Due to such constraints, many enterprises underutilize microsites and therefore have reduced ability to reach users, including the increasing proportion of consumers using mobile devices that are most likely to retrieve microsites (e.g., to facilitate purchasing decisions). Accordingly, enterprises without responsive landing pages and other types of microsites may not be meaningfully engaging consumers and other users on mobile platforms.

### SUMMARY

A method for generating and publishing microsites implemented by one or more content management apparatuses includes providing a widget comprising one or more template fields, an input field, and an indication of an associated web service. The widget when executed is configured to send a web service request including a network address as a parameter to the web service, the network address received via the input field. A web service response is received from the web service. The web service response includes content extracted from a web page corresponding to the network address. One or more portions of the content are mapped to the template fields. The template fields are populated with the one or more portions of the content based on the mapping. A microsite is published based on the populated template fields.

A content management apparatus, comprising memory comprising programmed instructions stored thereon and one or more processors configured to be capable of executing the stored programmed instructions to provide a widget comprising one or more template fields, an input field, and an indication of an associated web service. The widget when executed is configured to send a web service request including a network address as a parameter to the web service, the network address received via the input field. A web service response is received from the web service. The web service response includes content extracted from a web page corresponding to the network address. One or more portions of the content are mapped to the template fields. The template fields are populated with the one or more portions of the content based on the mapping. A microsite is published based on the populated template fields.

A non-transitory computer readable medium having stored thereon instructions for generating and publishing microsites comprising executable code which when executed by one or more processors, causes the one or more processors to provide a widget comprising one or more template fields, an input field, and an indication of an associated web service. The widget when executed is configured to send a web service request including a network address as a parameter to the web service, the network address received via the input field. A web service response is received from the web service. The web service response includes content extracted from a web page corresponding to the network address. One or more portions of the content are mapped to the template fields. The template fields are populated with the one or more portions of the content based on the mapping. A microsite is published based on the populated template fields.

A method for generating and publishing microsites implemented by one or more content management apparatuses includes receiving a web service request from a widget. The web service request comprising a network address of a web page as a parameter. The web page is retrieved from one or more server devices and loaded. A data extractor function is applied to extract content from the web page. A web service response is returned to the widget. The web service response includes one or more portions of the extracted content mapped to one or more predefined template fields of the widget.

A content management apparatus, comprising memory comprising programmed instructions stored thereon and one or more processors configured to be capable of executing the stored programmed instructions to receive a web service request from a widget. The web service request comprising a network address of a web page as a parameter. The web page is retrieved from one or more server devices and loaded. A data extractor function is applied to extract content from the web page. A web service response is returned to the widget. The web service response includes one or more portions of the extracted content mapped to one or more predefined template fields of the widget.

A non-transitory computer readable medium having stored thereon instructions for generating and publishing microsites comprising executable code which when executed by one or more processors, causes the one or more processors to receive a web service request from a widget. The web service request comprising a network address of a web page as a parameter. The web page is retrieved from one or more server devices and loaded. A data extractor function is applied to extract content from the web page. A web service response is returned to the widget. The web service response includes one or more portions of the extracted content mapped to one or more predefined template fields of the widget.

This technology provides a number of advantages including providing methods, non-transitory computer readable media, and content management apparatuses that facilitate more effective and efficient generation and publication of microsites. With this technology, widgets with template input fields are provided that are configured to communicate with web services to automatically retrieve content from content source web pages to be published as a microsite. Accordingly, a user can generate and publish a microsite relatively quickly without any technical knowledge of the platform used to host a content source web page. By facilitating efficient generation and publishing of microsites, this technology allows web site hosts to more effectively reach mobile device users, resulting in improved user engagement.

### BRIEF DESCRIPTION OF THE DRAWINGS

FIG. 1 is a block diagram of a network environment with an exemplary content management apparatus;

FIG. 2 is a block diagram of an exemplary microsite generator device of a content management apparatus;

FIG. 3 is a block diagram of an exemplary web service device of a content management apparatus;

FIG. 4 is a flow chart of an exemplary method for providing, by a microsite generator device of a content management apparatus, a widget configured to facilitate generation and publication of a microsite;

FIG. 5 is an exemplary widget with template fields that can be provided by a microsite generator device of a content management apparatus;

FIG. 6 is a flow chart of an exemplary method for populating, by a widget, template fields with content to be published on a microsite;

FIG. 7 is the exemplary widget of FIG. 5 with the template fields populated with content in an editable format;

FIG. 8 is the exemplary widget of FIG. 5 with the template fields populated with content in an uneditable format; and

FIG. 9 is a flow chart of an exemplary method for retrieving, by a web service device of a content management apparatus, content to be included on a microsite in response to an invocation of a web service by a widget.

### DETAILED DESCRIPTION

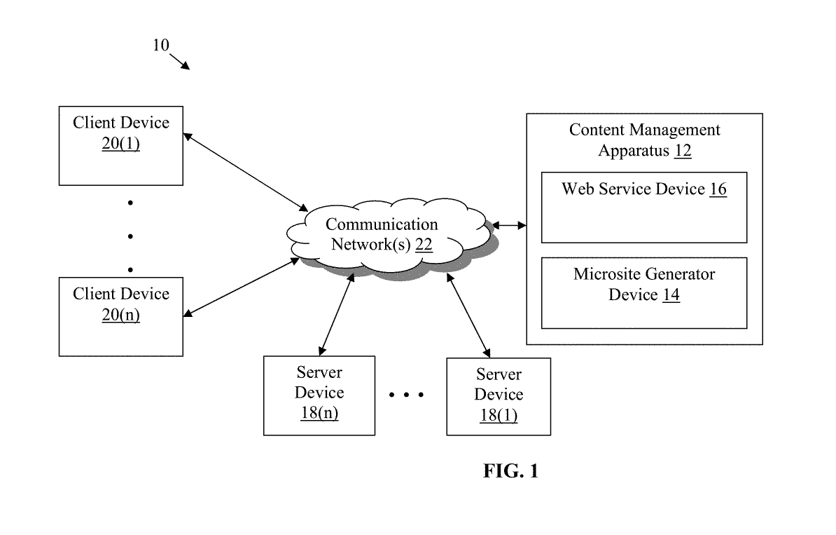

Referring to FIG. 1, an exemplary network environment 10 with an exemplary content management apparatus 12 is illustrated. The content management apparatus 12 in this example includes a microsite generator device 14 and a web service device 16, and is coupled to a plurality of server devices 168(1)-18(n) and a plurality of client devices 20(1)-20(n) via communication network(s) 22, although the content management apparatus 12, server devices 18(1)-18(n), and/or client devices 20(1)-20(n), may be coupled together via other topologies. Additionally, the network environment 10 may include other network devices such as one or more routers and/or switches, for example, which are well known in the art and thus will not be described herein. This technology provides a number of advantages including methods, non-transitory computer readable media, and content management apparatuses that facilitate more efficient generation and publication of microsites.

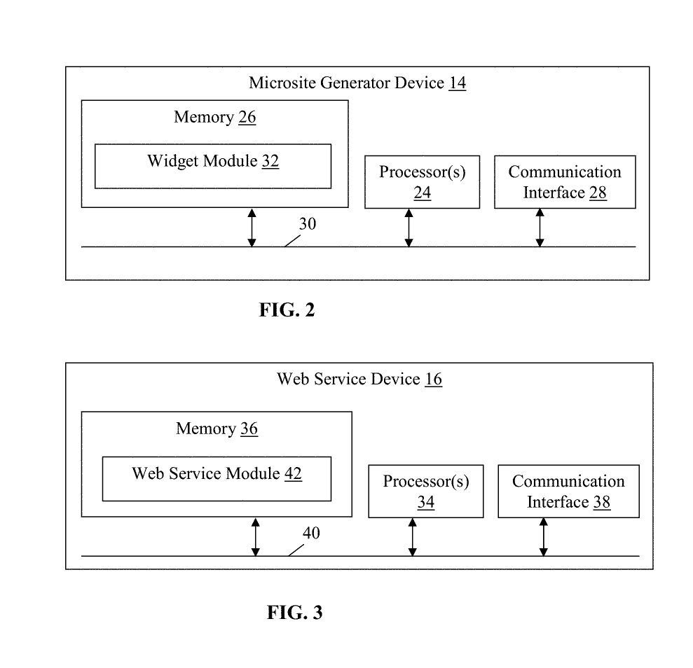

Referring to FIGS. 1-2, the microsite generator device 14 of the content management apparatus 12 generates and provides widgets that can be used at the client devices 20(1)-20(n) to generate and publish microsites. The microsite generator device 14 in this example includes one or more processors 24, a memory 26, and/or a communication interface 28, which are coupled together by a bus 30 or other communication link, although the microsite generator device 14 can include other types and/or numbers of elements in other configurations.

The processor(s) 24 of the microsite generator device 14 may execute programmed instructions stored in the memory 26 for the any number of the functions identified above. The processor(s) 24 of the microsite generator device 14 may include one or more CPUs or general purpose processors with one or more processing cores, for example, although other types of processor(s) can also be used.

The memory 26 of the microsite generator device 14 stores these programmed instructions for one or more aspects of the present technology as described and illustrated herein, although some or all of the programmed instructions could be stored elsewhere. A variety of different types of memory storage devices, such as random access memory (RAM), read only memory (ROM), hard disk, solid state drives, flash memory, or other computer readable medium which is read from and written to by a magnetic, optical, or other reading and writing system that is coupled to the processor(s) 24, can be used for the memory 26.

Accordingly, the memory 26 of the microsite generator device 14 can store one or more applications that can include computer executable instructions that, when executed by the microsite generator device 14, cause the microsite generator device 14 to perform actions, such as to transmit, receive, or otherwise process messages, for example, and to perform other actions described and illustrated below with reference to FIGS. 4-9. The application(s) can be implemented as modules or components of other applications. Further, the application(s) can be implemented as operating system extensions, module, plugins, or the like.

Even further, the application(s) may be operative in a cloud-based computing environment. The application(s) can be executed within or as virtual machine(s) or virtual server(s) that may be managed in a cloud-based computing environment. Also, the application(s), and even the microsite generator device 14 itself, may be located in virtual server(s) running in a cloud-based computing environment rather than being tied to one or more specific physical network computing devices. Also, the application(s) may be running in one or more virtual machines (VMs) executing on the microsite generator device 14. Additionally, in one or more embodiments of this technology, virtual machine(s) running on the microsite generator device 14 may be managed or supervised by a hypervisor.

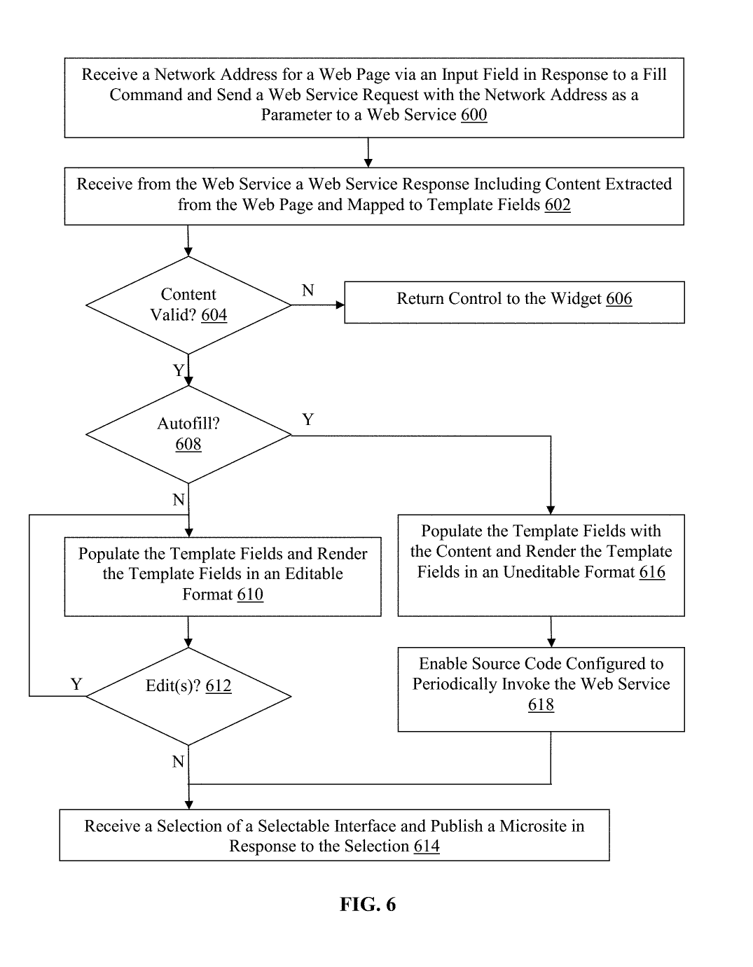

In this particular example, the memory 26 of the microsite generator device 14 includes a widget module 32, although the memory 26 can include other policies, modules, databases, or applications, for example. The widget module 32 in this example is configured to generate and provide a widget to the client devices 20(1)-20(n) upon request. The widgets include template and other fields that can be populated to facilitate the generation of a microsite, as described and illustrated in more detail later with reference to FIG. 6.

The communication interface 28 of the microsite generator device 14 operatively couples and communicates between the microsite generator device 14, the server devices 18(1)-18(n), and/or the client devices 20(1)-20(n), which are all coupled together by the communication network(s) 22, although other types and/or numbers of communication networks or systems with other types and/or numbers of connections and/or configurations to other devices and/or elements can also be used.

By way of example only, the communication network(s) 22 can include local area network(s) (LAN(s)) or wide area network(s) (WAN(s)), and can use TCP/IP over Ethernet and industry-standard protocols, although other types and/or numbers of protocols and/or communication networks can be used. The communication network(s) 22 in this example can employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

Referring to FIGS. 1 and 3, the web service device 16 of the content management apparatus 12 hosts web services that can be invoked by widgets provided by the microsite generator device 14 to automatically retrieve content to be included on a microsite. The web service device 16 in this example includes one or more processors 34, a memory 36, and/or a communication interface 38, which are coupled together by a bus 40 or other communication link, although the web service device 16 can include other types and/or numbers of elements in other configurations.

The processor(s) 34 of the web service device 16 may execute programmed instructions stored in the memory 36 for the any number of the functions identified above. The processor(s) 34 of the web service device 16 may include one or more CPUs or general purpose processors with one or more processing cores, for example, although other types of processor(s) can also be used.

The memory 36 of the web service device 16 stores these programmed instructions for one or more aspects of the present technology, as described and illustrated herein, although some or all of the programmed instructions could be stored elsewhere. A variety of different types of memory storage devices, such as random access memory (RAM), read only memory (ROM), hard disk, solid state drives, flash memory, or other computer readable medium which is read from and written to by a magnetic, optical, or other reading and writing system that is coupled to the processor(s) 34, can be used for the memory 42.

Accordingly, the memory 36 of the web service device 16 can store one or more applications that can include computer executable instructions that, when executed by the web service device 16, cause the web service device 16 to perform actions, such as to transmit, receive, or otherwise process messages, for example, and to perform other actions described and illustrated below with reference to FIGS. 4-9. The application(s) can be implemented as modules or components of other applications. Further, the application(s) can be implemented as operating system extensions, module, plugins, or the like.

Even further, the application(s) may be operative in a cloud-based computing environment. The application(s) can be executed within or as virtual machine(s) or virtual server(s) that may be managed in a cloud-based computing environment. Also, the application(s), and even the microsite generator device 14 itself, may be located in virtual server(s) running in a cloud-based computing environment rather than being tied to one or more specific physical network computing devices. Also, the application(s) may be running in one or more virtual machines (VMs) executing on the web service device 16. Additionally, in one or more embodiments of this technology, virtual machine(s) running on the web service device 16 may be managed or supervised by a hypervisor.

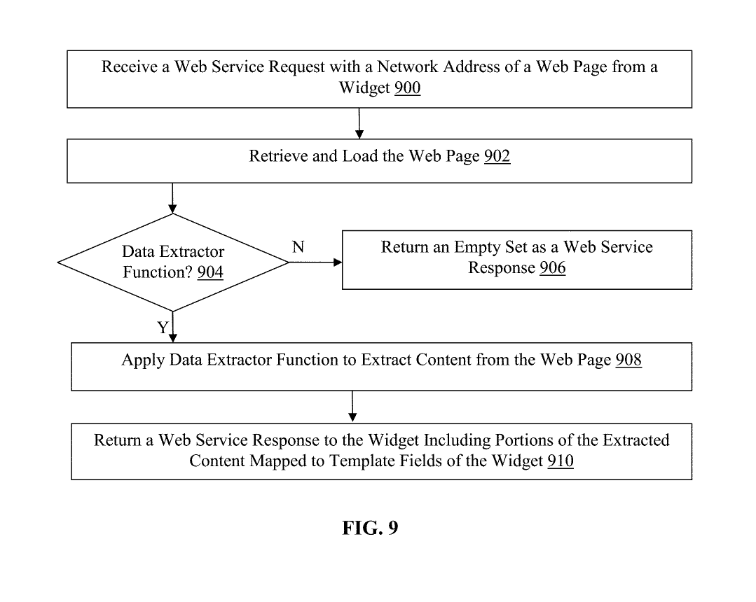

In this particular example, the memory 36 of the web service device 16 includes a web service module 42, although the memory 36 can include other policies, modules, databases, or applications, for example. The web service module 42 in this example includes implementation(s) for web service(s) accessible via endpoint(s), for example, which can be invoked by widgets to automatically retrieve content of a main or source web page, stored by one or more of the server device 18(1)-18(n), to include on a microsite, as described and illustrated in more detail later with reference to FIG. 9.

The communication interface 38 of the web service device 16 operatively couples and communicates between the web service device 16, the server devices 18(1)-18(n), and/or the client devices 20(1)-20(n), which are all coupled together by the communication network(s) 22, although other types and/or numbers of communication networks or systems with other types and/or numbers of connections and/or configurations to other devices and/or elements can also be used.

One or more of the devices that together comprise the content management apparatus 12 can be standalone devices or integrated with one or more other devices or apparatuses, such as one of the server devices 16(1)-16(n), for example. In one particular example, the web service device 16 can be one of the server devices 18(1)-18(n) and/or the web service module 42 can be hosted by one of the server devices 18(1)-18(n), and other arrangements are also possible. Moreover, one or more of the devices of the content management apparatus 12 can be in a same or a different communication network including one or more public, private, or cloud networks, for example.

Each of the server devices 18(1)-18(n) in this example includes one or more processors, a memory, and a communication interface, which are coupled together by a bus or other communication link, although other numbers and/or types of network devices could be used. The server devices 18(1)-18(n) in this example process messages received from the client devices 20(1)-20(n) and/or web service device 16 via the communication network(s) 22 according to the HTTP-based application RFC protocol, for example.

The server devices 18(1)-18(n) may be hardware or software or may represent a system with multiple servers in a pool, which may include internal or external networks. The server devices 18(1)-18(n) may host web sites including a plurality of web pages that can be accessed by the client device 20(1)-20(n) and the web service device 16. In particular, the server devices 18(1)-18(n) can host main or source web pages from which content can be extracted by a web service of the web service module 42 for inclusion on a microsite, as described and illustrated in more detail later.

Although the server devices 18(1)-18(n) are illustrated as single devices, one or more actions of each of the server devices 18(1)-18(n) may be distributed across one or more distinct network computing devices that together comprise one or more of the server devices 18(1)-18(n). Moreover, the server devices 18(1)-18(n) are not limited to a particular configuration. Thus, the server devices 18(1)-18(n) may contain a plurality of network computing devices that operate using a master/slave approach, whereby one of the network computing devices of the server devices 18(1)-18(n) operate to manage and/or otherwise coordinate operations of the other network computing devices.

The server devices 18(1)-18(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The client devices 20(1)-20(n) in this example include any type of computing device that can receive, render, and facilitate user interaction with graphical user interfaces and web content, such as mobile computing devices, desktop computing devices, laptop computing devices, tablet computing devices, virtual machines (including cloud-based computers), or the like. Each of the client devices 20(1)-20(n) in this example includes a processor, a memory, and a communication interface, which are coupled together by a bus or other communication link, although other numbers and/or types of network devices could be used.

The client devices 20(1)-20(n) may run interface applications, such as standard web browsers or standalone client applications, which may provide an interface to communicate with the content management apparatus 12 via the communication network(s) 22 in order to initiate the generation and publication of a microsite, including by obtaining and facilitating interactions with a widget, as described and illustrated in more detail later. The client devices 20(1)-20(n) may further include a display device, such as a display screen or touchscreen, and/or an input device, such as a keyboard, for example.

Although the exemplary network environment 10 with the content management apparatus 12, server devices 18(1)-18(n), client devices 20(1)-20(n), and communication network(s) 22 are described and illustrated herein, other types and/or numbers of systems, devices, components, and/or elements in other topologies can be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 10, such as the content management apparatus 12, client devices 20(1)-20(n), or server devices 18(1)-18(n), for example, may be configured to operate as virtual instances on the same physical machine. In other words, one or more of the content management apparatus 12, client devices 20(1)-20(n), or server devices 18(1)-18(n) may operate on the same physical device rather than as separate devices communicating through communication network(s) 22. Additionally, there may be more or fewer content management apparatuses, client devices, or server devices than illustrated in FIG. 1.

In addition, two or more computing systems or devices can be substituted for any one of the systems or devices in any example. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

An exemplary method of generating and publishing microsites will now be described with reference to FIGS. 1-9. Referring more specifically to FIG. 4, a method of providing a widget configured to facilitate generation and publication of a microsite is illustrated. In step 400 in this example, the microsite generator device 14 of the content management apparatus 12 receives a request from one of the client devices 20(1)-20(n) to generate a widget. The request can be received via a web interface over communication network(s) 22, for example.

In step 402, the microsite generator device 14 of the content management apparatus 12 identifies a stored widget or generates a widget based on the request. A widget in this example can be a web page or any other type of graphical interface having source code that, when executed by one of the client devices 20(1)-20(n), is configured to carry out the method described and illustrated in more detail later with reference to FIG. 6.

In one example, the request received in step 400 can include a reference to a domain host (e.g. CNN) or other indication of a web site that can be used by the widget module 32 to identify a stored widget. In another example, the widget module 32 can be configured to automatically generate a widget that can be used across one or more domains irrespective of any particular information included in the received request. In yet another example, the request can include an indication of particular content (e.g., product image and price) to be included on a microsite, which the widget module 32 can use to generate a widget with corresponding template fields. Other methods of identifying or generating a widget can also be used.

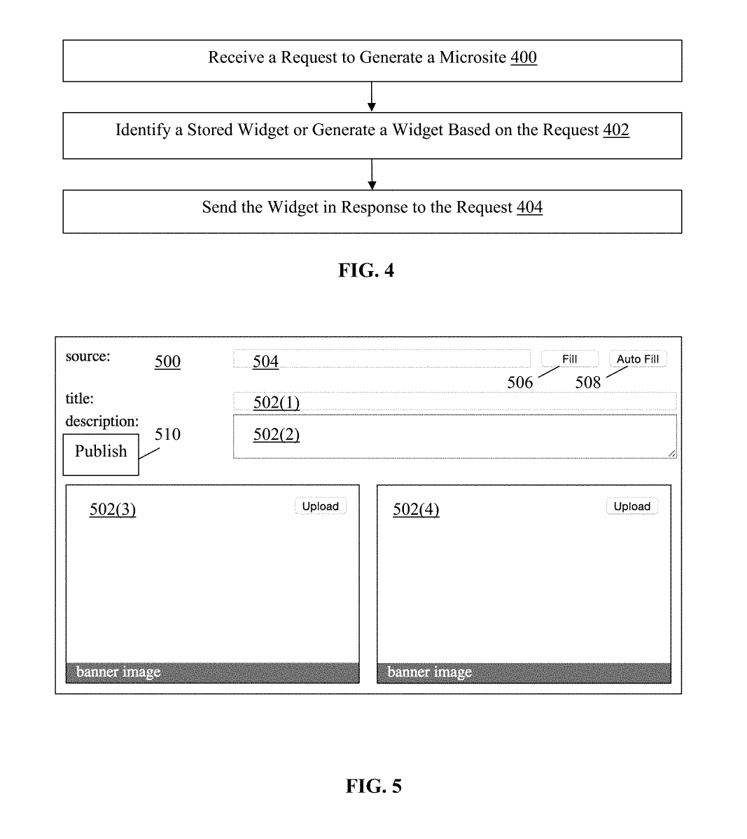

Referring more specifically to FIG. 5, an exemplary widget 500 with template fields 502(1)-502(4) that can be identified or generated by the microsite generator device 14 of the content management apparatus 12 in step 402 is illustrated. In this particular example, the widget 500 includes a title template field 502(1), a description template field 502(2), and two banner image template fields 502(3) and 502(4). Additionally, the widget 500 includes an input field 504 for receiving a network address of a web page that will be the content source for the microsite.

The widget 500 in this example further includes a fill button 506 and an auto fill button 508 that are configured to generate fill commands when selected by a user of one of the client devices 20(1)-20(n). A selectable interface 510 configured to facilitate publishing of a microsite is also provided on the widget 500 in this example. In other examples, other types or numbers of template fields, input fields, buttons, or other interface features can be included in the widget 500 generated in step 402.

Referring back to FIG. 4, in step 404, the microsite generator device 14 of the content management apparatus 12 sends the widget 500 identified or generated in step 402 to the one of the client devices 20(1)-20(n) in response to the request received from the one of the client devices 20(1)-20(n) received in step 400. The widget 500 can be sent to the one of the client devices 20(1)-20(n) by the widget module 32 and via the communication network(s) 22, for example.

Referring more specifically to FIG. 6, a method for populating the template fields 502(1)-502(4) of the widget 500 with content is illustrated. In step 600 in this example, the widget 500, executed by one of the client devices 20(1)-20(n) to which the widget 500 was previously sent by the microsite generator device 14, receives a network address for a web page in response to a fill command initiated by a user of the one of the client devices 20(1)-20(n). In one example, a user of the one of the client devices 20(1)-20(n) can enter text comprising a network address of a web page into the input field 504 of the widget 500, and select the fill button 506 or the auto fill button 508.

In response to the selection of the fill button 506 or the auto fill button 508, a fill command is generated, which is processed by source code of the widget 500 by obtaining the network address entered into the input field 504 and sending a web service request with the network address as a parameter. The web service request can be sent to the web service device 16, for example, and in particular to an endpoint associated with the web service module 42. The endpoint can be included in the source code of the widget 500 upon generation of the widget 500 in step 402 of FIG. 4, for example.

The network address entered by the user and sent to the web service can be for a web page that will be a content source for the microsite to be generated and published. In one example, the web service request is sent using JavaScript Object Notation with Padding (JSONP). By using JSONP, this technology allows the web service request to be sent to a web service hosted by a web service device 16 that may be separate from (e.g., based on IP address) the microsite generator device 14 from which the widget 500 was received by the one of the client devices 20(1)-20(n).

In step 602, the widget 500, executed by the one of the client devices 20(1)-20(n), receives from the web service hosted by the web service device 16 a response including content extracted from the web page associated with the network address that was passed to the web service upon invocation of the web service by the widget 500. The content is mapped to the template input fields 502(1)-502(4) by the web service in this example. The operation of the web service hosted by the web service device 16 is described and illustrated in more detail later with reference to FIG. 9.

In step 604, the widget 500, executed by the one of the client devices 20(1)-20(n), optionally determines whether the content included in the web service response is valid. In one example, the content can be invalid if an empty set is returned from the web service. In another example, content for only a subset of the template fields 502(1)-502(4) may be included in the web service response, which may result in a determination that the content is not valid. In yet another example, the content included in the web service response may not be of a type corresponding to a type of one or more of the template fields 502(1)-502(4) (e.g., an image mapped to the text-based title template field 502(1)). If the widget 500 determines that the content included in the web service response is not valid, then the No branch is taken to step 606.

In step 606, control is returned to the widget 500 to allow the user of the one of the client devices 20(1)-20(n) to address the failure (e.g., by correcting an incorrect network address entered into the input field 504). In this example, control is obtained from the widget 500 while the web service is invoked and the widget awaits a web service response. Optionally, the widget 500 can be configured to display a failure message or automatically generate a redirect, and other actions or responses can also be initiated in step 606 in other examples. However, if the widget 500 determines in step 604 that the content included in the web service response is valid, then the Yes branch is taken to step 608.

In step 608, the widget 500, executed by the one of the client devices 20(1)-20(n), optionally determines whether the fill command received in step 600 was of an autofill type. The fill command can be of an autofill type when the fill command is initiated following selection of the auto fill button 508 by a user in this example, although other ways of initiating a fill command of an autofill type can also be used in other examples.

In some examples, the microsite generated and published using this technology can be configured to automatically and periodically fill with content so as to reflect any changes occurring in the web page from which the content was extracted by the web service, as described and illustrated in more detail later. Accordingly, if the widget 500 determines that the fill command was not of an auto fill type (e.g., when the fill command was initiated in response to selection of the fill button 506), then the No branch is taken to step 610.

In step 610, the widget 500, executed by the one of the client devices 20(1)-20(n), populates the template fields 502(1)-502(4) with the content included in the web service response received in step 602. Appropriate ones of the template fields 502(1)-502(4) for portions of the content can be identified based on the mapping of the content to the template fields 502(1)-502(4) in the web service response.

In this example, the content is rendered in an editable format. Since the fill command initiated in step 600 was not of an autofill type, the microsite published using the widget 500 will be static, and not periodically updated. Accordingly, the user of the one of the client devices 20(1)-20(n) can optionally edit one or more of the template fields 502(1)-502(4), and the edit(s) will be reflected on the published microsite for the duration of the lifespan of the microsite.

Referring more specifically to FIG. 7, the widget 500 with the template fields 502(1)-502(4) populated with content in an editable format is illustrated. In this particular example, the template fields 502(3) and 502(4) correspond with images extracted from a content source web page. Upon rendering content in the template fields 502(3) and 502(4), upload buttons 700(1) and 700(2) are introduced to allow a user of the one of the client devices 20(1)-20(n) to replace the extracted images with other images, such as may be stored locally on the one of the client devices 20(1)-20(n), for example.

Referring back to FIG. 6, in step 612, the widget 500, executed by the one of the client devices 20(1)-20(n), determines whether there are any edits initiated by a user of the one of the client devices 20(1)-20(n) (e.g., by selection of one of the upload buttons 700(1) or 700(2)). If the widget 500 determines that an edit is initiated, then the Yes branch is taken back to step 610 in which the edit is processed and the corresponding one of the template fields 502(1)-502(4) is again rendered in an editable format. However, if the widget 500 determines in step 612 that there are no edits, then the No branch is taken to step 614.

In step 614, the widget 500, executed by the one of the client devices 20(1)-20(n), receives a selection of the selectable interface 510 and publishes the widget 500 as a microsite in response to the selection. In one example, the widget 500 can determine that there are no more edits in step 612 based on a received selection the selectable interface 510, although other methods of determining that there are no more edits can also be used. The selectable interface 510 can be a button or link, for example, associated with a social media platform or messaging system.

Although only one selectable interface 510 is illustrated in this example, any number of selectable interfaces (e.g., associated with a plurality of social networks) can also be provided in other examples. Optionally, the widget 500 can use an application programming interface (API) of a social network or other messaging service to publish the populated template fields 502(1)-502(4) as a microsite web page, although other methods of publishing the microsite can also be used.

Referring back to step 608, if the widget 500 determines that the fill command received in step 600 was of an autofill type, then the Yes branch is taken to step 616. In step 616, the widget 500, executed by the one of the client devices 20(1)-20(n), populates the template fields 502(1)-502(4) with content based on the mapping included in the web service response and renders the content in the template fields 502(1)-502(4) in an uneditable format.

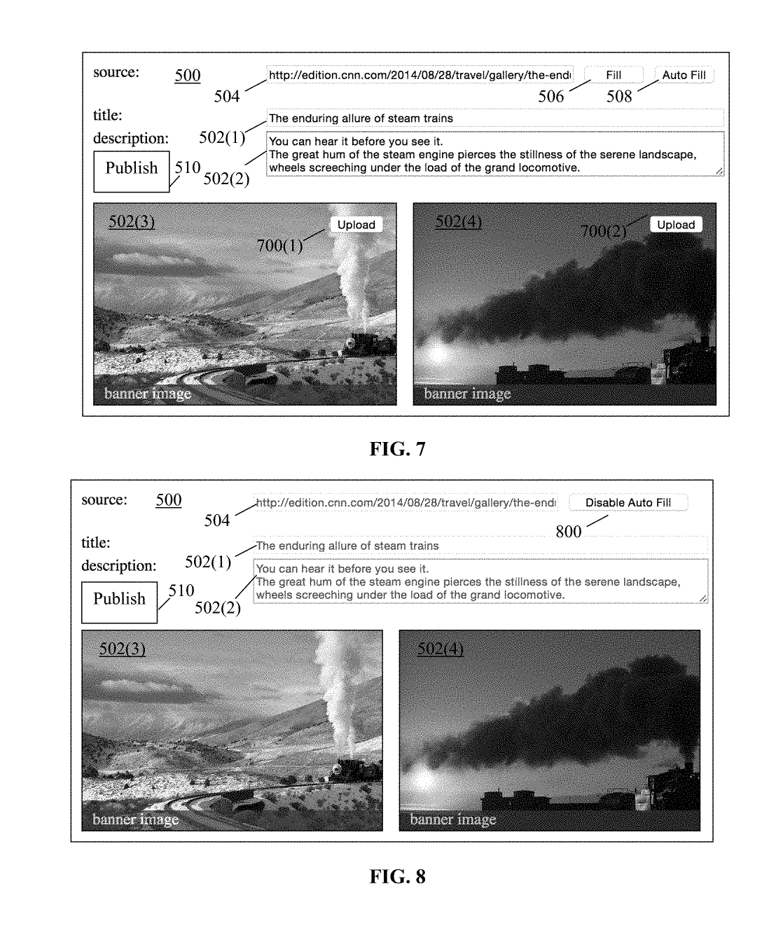

Referring more specifically to FIG. 8, the widget 500 of FIG. 5 with the template fields 502(1)-502(4) populated with content in an uneditable format is illustrated. In particular, the upload buttons 700(1) and 700(2) included in the template fields 502(3) and 502(4) in FIG. 7 are not included in those template fields in the example illustrated in FIG. 8. Optionally, upon rendering the content in the template fields 502(1)-502(4), the widget 500 in this example can replace the fill button 506 and autofill button 508 with a disable autofill button 800 to allow a user of the one of the client devices 20(1)-20(n) to toggle between editable and uneditable template fields 502(1)-502(4) of the widget 500.

In step 618, the widget 500, executed by the one of the client devices 20(1)-20(n), enables source code configured to periodically invoke the web service called in step 600. Optionally, the widget 500 is provided by the microsite generator device 14 with source code configured to periodically invoke the web service at an established interval, which can be enabled such that the web service is periodically invoked subsequent to publishing the widget 500 as a microsite.

The enabled source code is further configured to receive the web service response, as described and illustrated earlier with reference to step 602, and repopulate one or more of the template fields 502(1)-502(4), as described and illustrated earlier with reference to step 616, of the published microsite with updated content, if necessary. Subsequent to enabling the source code in step 618, the widget 500 proceeds to receive a selection of the selectable interface 510 and publish the widget 500 as a microsite, as described and illustrated in more detail earlier.

Referring more specifically to FIG. 9, a method for retrieving content to be included on a microsite in response to an invocation of a web service by the widget 500 is illustrated. In step 900 in this example, the web service device 16 of the content management apparatus 12 receives a web service request, such as at a web service defined in the web service module 42, from the widget 500. The web service request includes a parameter including a network address for a web page. The web service request could have been sent following invocation of the web service by the widget 500 as described and illustrated in more detail earlier with reference to step 600 of FIG. 6.

In step 902, the web service device 16 of the content management apparatus 12 retrieves and loads the web page corresponding to the network address included in the received web service request. The web page can be retrieved from one of server devices 18(1)-18(n), for example. The web page is a content source for the microsite to be published from which the web service is configured to automatically extract content corresponding to template fields of the widget 500.

In step 904, the web service device 16 of the content management apparatus 12 determines whether a data extractor function can be identified. A data extractor function in this example is a predefined callback function stored by the web service module 42, for example, which is configured to extract valid data from the web page loaded in step 902.

In one example, the data extractor function is identified based on the network address received with the web service response in step 900 (e.g., a uniform resource locator (URL) network address including “www.cnn.com” will correspond to a stored CNN data extractor function). In another example, the data extractor can be identified based on content of the loaded web page (e.g., a markup in a header), and other methods for identifying the data extract function can also be used. If the web service device 16 determines that a data extractor function cannot be identified, then the No branch is taken to step 906.

In step 906, the web service device 16 of the content management apparatus 12 returns an empty set as a web service response to the web service request received in step 900. Accordingly, if a data extract function cannot be identified, then the loaded web page is not preconfigured as a microsite content source. Other types of information can also be included in the web service response to indicate that the web service request cannot be satisfied. However, if the web service device 16 determines in step 904 that a data extractor function can be identified, then the Yes branch is taken to step 908.

In step 908, the web service device 16 of the content management apparatus 12 applies the data extractor function to extract content from the web page. In the example described and illustrated herein, the data extractor function is configured to extract a title, description, and two images corresponding with the template fields 502(1)-502(4), although any other number or type of content can also be extracted from a source web page in other examples. Accordingly, the data extractor function is configured to extract only a subset of the content hosted by the content source web page that is required for inclusion on the microsite to be published.

In step 910, the web service device 16 of the content management apparatus 12 returns a web service response to the widget 500 in response to the web service request received in step 900. The web service response includes portions of the extracted content mapped to the template fields 502(1)-502(4) of the widget 500. In one example, the web service hosted by the web service device 16 can be preconfigured with an indication of, or variables corresponding to, the template fields 502(1)-502(4) that can be used for the mapping, although other methods of identifying the template fields 502(1)-502(4) can be used.

Accordingly, the data extractor function can return content including a title, a description, and two banner images in the example described and illustrated earlier, and the web service can generate the mapping of portions of the content using variables for the template fields 502(1)-502(4) that are interpretable by the widget 500. The web service response with the mapped content can be received by the widget 500 as described and illustrated earlier with reference to step 602 of FIG. 6, and the widget 500 can be populated and published as a microsite, as described and illustrated earlier with reference to steps 604-614 of FIG. 6.

This technology advantageously facilitates efficient generation and publication of microsites. With this technology, a user simply needs to request a widget, provide a network address for a content source web page, and invoke a selectable interface for a publication destination or platform in order to generate and publish a microsite. Accordingly, users can publish microsites without any technical knowledge of the underlying platform hosting the content source web page. By facilitating efficient publication of microsites, this technology advantageously leads to increased web site traffic from mobile devices and improved engagement with users and consumers.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for generating and publishing microsites implemented by one or more content management apparatuses, the method comprising providing a widget comprising one or more template fields, an input field, and an indication of an associated web service, wherein the widget when executed is configured to:
send a web service request including a network address as a parameter to the web service, the network address received via the input field;
receive a web service response from the web service, the web service response comprising content extracted from a web page corresponding to the network address, wherein one or more portions of the content are mapped to the template fields;
populate the template fields with the one or more portions of the content based on the mapping; and
publish a microsite based on the populated template fields.

2. The method of claim 1, wherein the web service request is sent in response to a received fill command and the widget when executed is further configured to:
determine when the fill command is of an automatic type;
render the template fields in an editable form subsequent to populating the template fields, when the determining indicates that the fill command is not of an automatic type; and
when the determining indicates that the fill command is of an automatic type:
render the template fields in an uneditable form subsequent to populating the template fields; and
enable source code configured to periodically repeat the sending the web service request, receiving the web service response, and populating of the template fields.

3. The method of claim 1, wherein the widget further comprises one or more selectable interfaces and the widget when executed is further configured to publish the microsite on one or more social media platforms or messaging systems corresponding to one of the selectable interfaces upon receiving a selection of the one of the selectable interfaces.

4. The method of claim 1, wherein the web service request is sent or the web service response is received using JavaScript Object Notation with Padding (JSONP).

5. A content management apparatus, comprising memory comprising programmed instructions stored thereon and one or more processors configured to be capable of executing the stored programmed instructions to provide a widget comprising one or more template fields, an input field, and an indication of an associated web service, wherein the widget when executed is configured to:
send a web service request including a network address as a parameter to the web service, the network address received via the input field;
receive a web service response from the web service, the web service response comprising content extracted from a web page corresponding to the network address, wherein one or more portions of the content are mapped to the template fields;
populate the template fields with the one or more portions of the content based on the mapping; and
publish a microsite based on the populated template fields.

6. The content management apparatus of claim 5, wherein the web service request is sent in response to a received fill command and the widget when executed is further configured to:
determine when the fill command is of an automatic type;
render the template fields in an editable form subsequent to populating the template fields, when the determining indicates that the fill command is not of an automatic type; and
when the determining indicates that the fill command is of an automatic type:
render the template fields in an uneditable form subsequent to populating the template fields; and
enable source code configured to periodically repeat the sending the web service request, receiving the web service response, and populating of the template fields.

7. The content management apparatus of claim 5, wherein the widget further comprises one or more selectable interfaces and the widget when executed is further configured to publish the microsite on one or more social media platforms or messaging systems corresponding to one of the selectable interfaces upon receiving a selection of the one of the selectable interfaces.

8. The content management apparatus of claim 5, wherein the web service request is sent or the web service response is received using JavaScript Object Notation with Padding (JSONP).

9. A non-transitory computer readable medium having stored thereon instructions for generating and publishing microsites comprising executable code which when executed by one or more processors, causes the one or more processors to provide a widget comprising one or more template fields, an input field, and an indication of an associated web service, wherein the widget when executed is configured to:
send a web service request including a network address as a parameter to the web service, the network address received via the input field;
receive a web service response from the web service, the web service response comprising content extracted from a web page corresponding to the network address, wherein one or more portions of the content are mapped to the template fields;
populate the template fields with the one or more portions of the content based on the mapping; and
publish a microsite based on the populated template fields.

10. The non-transitory computer readable medium of claim 9, wherein the web service request is sent in response to a received fill command and the widget when executed is further configured to:
determine when the fill command is of an automatic type;
render the template fields in an editable form subsequent to populating the template fields, when the determining indicates that the fill command is not of an automatic type; and
when the determining indicates that the fill command is of an automatic type:
render the template fields in an uneditable form subsequent to populating the template fields; and
enable source code configured to periodically repeat the sending the web service request, receiving the web service response, and populating of the template fields.

11. The non-transitory computer readable medium of claim 9, wherein the widget further comprises one or more selectable interfaces and the widget when executed is further configured to publish the microsite on one or more social media platforms or messaging systems corresponding to one of the selectable interfaces upon receiving a selection of the one of the selectable interfaces.

12. The non-transitory computer readable medium of claim 9, wherein the web service request is sent or the web service response is received using JavaScript Object Notation with Padding (JSONP).

13. A method for generating and publishing microsites implemented by one or more content management apparatuses, the method comprising:
receiving a web service request from a widget, the web service request comprising a network address of a web page as a parameter;
retrieving the web page from one or more server devices and loading the web page;
applying a data extractor function to extract content from the web page; and
returning a web service response to the widget, the web service response comprising one or more portions of the extracted content mapped to one or more template fields of the widget.

14. The method of claim 13, further comprising:
determining when the data extractor function can be identified based on the network address or one or more portions of source code of the web page; and
returning an empty set as the web service response when the determining indicates that the data extractor function cannot be identified.

15. The method of claim 13, wherein the web service request is received or the web service response is returned using JavaScript Object Notation with Padding (JSONP).

16. A content management apparatus, comprising memory comprising programmed instructions stored thereon and one or more processors configured to be capable of executing the stored programmed instructions to:
receive a web service request from a widget, the web service request comprising a network address of a web page as a parameter;
retrieve the web page from one or more server devices and loading the web page;
apply a data extractor function to extract content from the web page; and
return a web service response to the widget, the web service response comprising one or more portions of the extracted content mapped to one or more template fields of the widget.

17. The content management apparatus of claim 16, wherein the one or more processors are further configured to be capable of executing the stored programmed instructions to:
determine when the data extractor function can be identified based on the network address or one or more portions of source code of the web page; and
return an empty set as the web service response when the determining indicates that the data extractor function cannot be identified.

18. The content management apparatus of claim 16, wherein the web service request is received or the web service response is returned using JavaScript Object Notation with Padding (JSONP).

19. A non-transitory computer readable medium having stored thereon instructions for generating and publishing microsites comprising executable code which when executed by one or more processors, causes the one or more processors to:
receive a web service request from a widget, the web service request comprising a network address of a web page as a parameter;
retrieve the web page from one or more server devices and loading the web page;
apply a data extractor function to extract content from the web page; and
return a web service response to the widget, the web service response comprising one or more portions of the extracted content mapped to one or more template fields of the widget.

20. The non-transitory computer readable medium of claim 19, wherein the executable code when executed by the one or more processors further causes the one or more processors to:
determine when the data extractor function can be identified based on the network address or one or more portions of source code of the web page; and
return an empty set as the web service response when the determining indicates that the data extractor function cannot be identified.

21. The non-transitory computer readable medium of claim 19, wherein the web service request is received or the web service response is returned using JavaScript Object Notation with Padding (JSONP).
